(19) United States
(12) Patent Application Publication
(10) Pub. No.: US 2025/0247619 A1
(43) Pub. Date: Jul. 31, 2025

(54) METAL SPRING, VOICE COIL MOTOR, AND CAMERA

(71) Applicant: MEMS DRIVE NANJING LIMITED, NANJING (CN)

(72) Inventors: QIJUN HU, NANJING (CN); MATTHEW QING LIANG NG, NANJING (CN); TANGLIU YAN, NANJING (CN); GUIQIN WANG, NANJING (CN); XIAOLEI LIU, NANJING (CN)

(21) Appl. No.: 19/031,672

(22) Filed: Jan. 18, 2025

Related U.S. Application Data
(60) Provisional application No. 63/625,051, filed on Jan. 25, 2024.

(51) Int. Cl. H04N 23/68; F16F 3/02; H02K 7/12; H02K 41/035

(52) U.S. Cl. CPC H04N 23/687; F16F 3/023; H02K 7/12; H02K 41/0354

(57) ABSTRACT

A metal spring includes four spring members that are connected to each other from end to end. A reference plane in which the four spring members are arranged and are connected to each other is formed. Each spring member includes a spring portion, the spring portion is extending in a length direction and has a width in a width direction and a height in a height direction, the width direction and the length direction are extending in the reference plane and are perpendicular to each other, the height direction is perpendicular to the reference plane. A ratio of the height to the width of the respective spring portion is configured to enable each of the first spring member, the second spring member, the third spring member, and the fourth spring member to be capable of being displaced in only the reference plane.

### CROSS REFERENCE TO RELATED APPLICATIONS

This application claims priority to U.S. Provisional Application No. 63/625,051, entitled “High-Strength Bent Metal Spring” filed on Jan. 25, 2024, which is hereby incorporated by reference herein as if set forth in its entirety.

### TECHNICAL FIELD

Embodiments of the present disclosure relate to the technical field of metal springs for voice coil motors, and more specifically, to a metal spring, a voice coil motor, and a camera.

### BACKGROUND

A camera in the art is arranged with a voice coil motor (VCM) configured for optical image stabilization (OIS). For OIS, the VCM is configured to drive a sensor of the camera to move in one plane only (such as an X-Y plane). The driving is achieved by a metal spring included in the VCM.

The metal spring is a planar structure, as shown in FIG. 1, having a small thickness in the Z direction, i.e., the metal spring has a small stiffness in the Z direction. It is known that, when a force is applied, as a stiffness of a structure is lower, deformation of the structure is greater. Therefore, in the art, in order to achieve OIS, i.e., driving the sensor to move in only the X-Y plane, the planar metal spring is arranged with ball bearings. The ball bearings provide support in the Z direction for the planar metal spring, effectively increasing the stiffness of the metal spring in the Z direction, and therefore, the stiffness in the Z direction is much greater than the stiffness in the X-Y plane. Therefore, the metal spring can move in the XY plane only and cannot move along the Z direction.

However, the ball bearings generate non-linear friction, hampering precise displacement control of the VCM. Assembling the ball bearings requires increased assembly complexity and costs. Lubrication grease is usually required for the ball bearings to reduce friction. The ball bearings occupy a large space, increasing an overall size of the VCM. The friction generated by the ball bearings may cause higher power consumption of the VCM.

### SUMMARY

The present disclosure provides a metal spring, configured for a voice coil motor (VCM), the metal spring includes: a first spring member, a second spring member, a third spring member, and a fourth spring member. The first spring member and the third spring member are extending in parallel to each other; the second spring member is connected between an end of the first spring member and an end of the third spring member; the fourth spring member is connected between the other end of the first spring member and the other end of the third spring member. A reference plane in which the first spring member, the second spring member, the third spring member, and the fourth spring member are arranged and connected to each other is formed. Each of the first spring member, the second spring member, the third spring member, and the fourth spring member includes a respective spring portion, the spring portion is extending in a length direction and has a width in a width direction and a height in a height direction, the width direction and the length direction are extending in the reference plane and are perpendicular to each other, the height direction is perpendicular to the reference plane. A ratio of the height to the width of the respective spring portion is configured to enable each of the first spring member, the second spring member, the third spring member, and the fourth spring member to be capable of being displaced in only the reference plane.

The present disclosure further provides a voice coil motor, including: the metal spring as described in the above; a movable member; and a fixed member. The movable member is connected to the first spring member and the third spring member; the fixed member is connected to the second spring member and the fourth spring member.

The present disclosure further provides a camera, including a lens and the voice coil motor as described in the above.

### BRIEF DESCRIPTION OF THE DRAWINGS

In order to more clearly illustrate technical solutions in embodiments of the present disclosure, accompanying drawings used in the embodiments will be briefly introduced below. Obviously, the accompanying drawings in the following description show only some of the embodiments of the present disclosure, and any ordinary skilled person in the art may obtain other accompanying drawings based on these drawings without creative work.

FIG. 1 is a structural schematic view of a planar metal spring in the art.

FIG. 2 is a structural schematic view of a planar metal spring according to an embodiment of the present disclosure.

FIG. 3 is a structural schematic view of the planar metal spring being disassembled according to an embodiment of the present disclosure.

FIG. 4 is a top plane view of a voice coil motor (VCM) arranged with the planar metal spring according to an embodiment of the present disclosure.

FIG. 5 is a cross-sectional view of a camera arranged with the VCM according to an embodiment of the present disclosure.

### DETAILED DESCRIPTIONS

It should be noted that terms “first”, “second” and “third” in the present disclosure are used to distinguish different objects from each other and shall not be used to describe a particular order. Furthermore, the terms “include” and “have”, and any variations thereof, are intended to cover non-exclusive inclusion. For example, a process, a method, a system, a product, or an apparatus that includes a series of steps or modules is not limited to the listed steps or modules, but further includes steps or modules that are not listed or includes steps or modules that are inherently included in the process, the method, the system, the product, or the apparatus.

Reference to “embodiments” implies that particular features, structures, or characteristics described in an embodiment may be included in at least one embodiment of the present disclosure. Presence of the term at various sections in the specification does not necessarily refer to one same embodiment or to separate or alternative embodiments that are mutually exclusive to other embodiments. Any ordinary skilled person in the art shall understand, both explicitly and implicitly, that the embodiments described herein may be combined with other embodiments.

In the art, a metal spring is a planar structure, as shown in FIG. 1, and is arranged in a voice coil motor (VCM) for a camera to achieve optical image stabilization (OIS). As shown in FIG. 1, the metal spring has a small thickness in the Z direction, i.e., the metal spring has a small stiffness in the Z direction. It is known that, when a force is applied, as a stiffness of a structure is lower, deformation of the structure is greater. Therefore, in the art, in order to achieve OIS, i.e., driving a sensor of the camera to move in only one plane, such as an X-Y plane, the planar metal spring is arranged with ball bearings. The ball bearings provide support in the Z direction for the planar metal spring, effectively increasing the stiffness of the metal spring in the Z direction, and therefore, the stiffness in the Z direction is much greater than the stiffness in the X-Y plane. Therefore, the metal spring can move in the XY plane only and cannot move along the Z direction.

However, the ball bearings generate non-linear friction, hampering precise displacement control of the VCM. Assembling the ball bearings requires increased assembly complexity and costs. Lubrication grease is usually required for the ball bearings to reduce friction. The ball bearings occupy a large space, increasing an overall size of the VCM. The friction generated by the ball bearings may cause higher power consumption of the VCM.

Therefore, the present application provides a metal spring 100 configured for a voice coil motor without arranging any ball bearing.

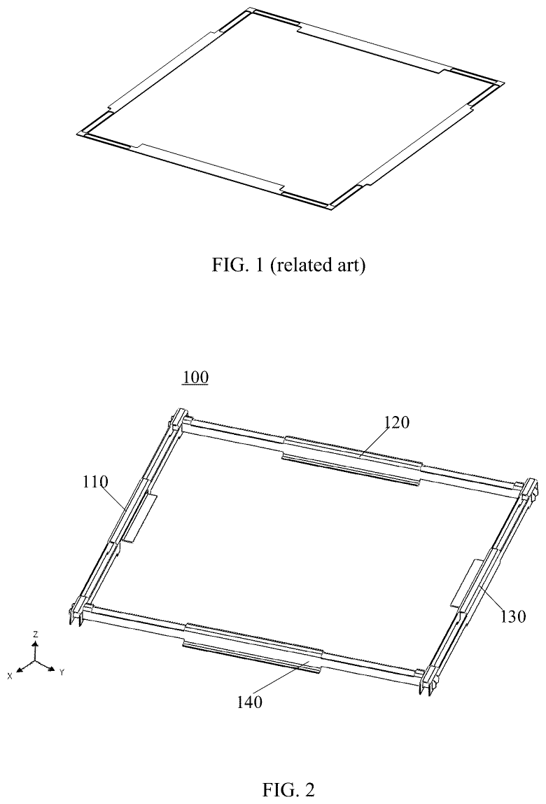

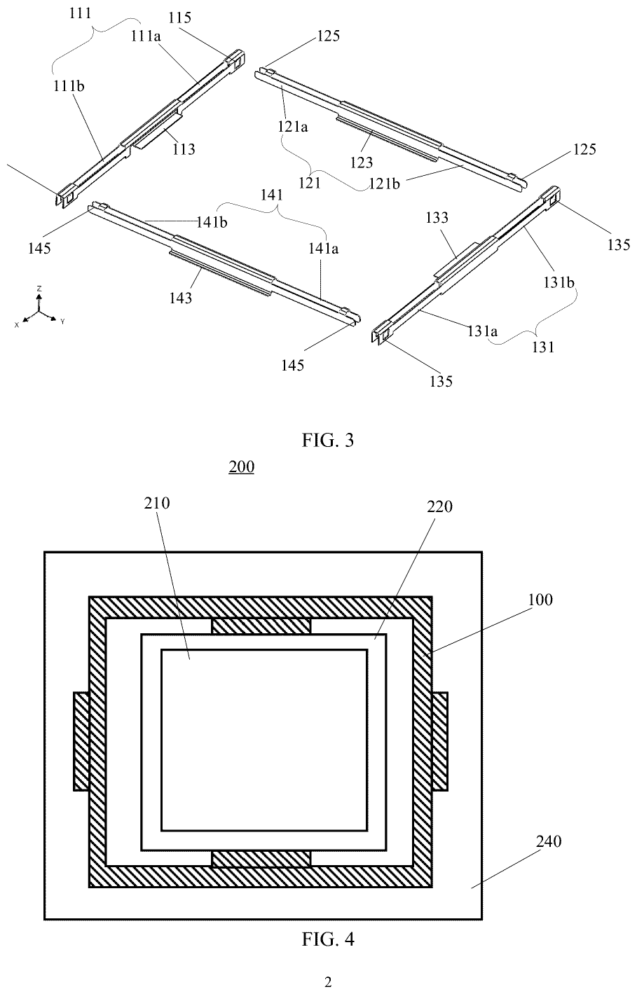

Specifically, as shown in FIGS. 2 and 3, the metal spring 100 includes a first spring member 110, a second spring member 120, a third spring member 130, and a fourth spring member 140. The first spring member 110, the second spring member 120, the third spring member 130, and the fourth spring member 140 are connected to each other from end to end. In detail, the first spring member 110 and the third spring member 130 are extending in parallel to each other; the second spring member 120 is connected between an end of the first spring member 110 and an end of the third spring member 130; the fourth spring member 140 is connected between the other end of the first spring member 110 and the other end of the third spring member 130. A reference plane in which the first spring member 110, the second spring member 120, the third spring member 130, and the fourth spring member 140 are arranged and are connected to each other is formed. For example, as shown in FIGS. 2 and 3, the reference plane is an X-Y plane.

The first spring member 110 includes a first spring portion 111, the second spring member 120 includes a second spring portion 121, the third spring member 130 includes a third spring portion 131, and the fourth spring member 140 includes a fourth spring portion 141. Each of the first spring portion 111, the second spring portion 121, the third spring portion 131, and the fourth spring portion 141 can generate an elastic force and is configured to take the elastic force to drive motions. Furthermore, due to being elastic, each of the first spring portion 111, the second spring portion 121, the third spring portion 131, and the fourth spring portion 141 is bendable in one or more directions. Each of the first spring portion 111, the second spring portion 121, the third spring portion 131, and the fourth spring portion 141 is extending in a length direction and has a width in a width direction and a height in a height direction. The width direction and the length direction are extending in the reference plane, i.e., the X-Y plane, and are perpendicular to each other, the height direction is perpendicular to the reference plane. For example, the height direction may be a Z direction as indicated in FIGS. 2 and 3.

For each of the first spring portion 111, the second spring portion 121, the third spring portion 131, and the fourth spring portion 141, a ratio of the height to the width is greater than 5:1, for example, the ratio of the height to the width may be 5.1:1, 5.5:1, 6:1, 6.4:1, 6.6:1, 7:1, and so on. A value of the ratio may not be the same as the specific values listed herein, as long as each of the first spring member 110, the second spring member 120, the third spring member 130, and the fourth spring member 140 is enabled to be displaced in only the X-Y reference plane. In this way, the height is significantly greater than the width, and therefore, for each of the first spring portion 111, the second spring portion 121, the third spring portion 131, and the fourth spring portion 141, a height stiffness in the height direction is significantly greater than a width stiffness in the width direction. For example, the height stiffness in the height direction may be 60 to 120 N/m.

In the present embodiment, each of the first spring portion 111, the second spring portion 121, the third spring portion 131, and the fourth spring portion 141 is sheet-shaped and is relatively regularly shaped. Therefore, the height, the width, and the length can be easily measured and designed. In other embodiments, any of the first spring portion 111, the second spring portion 121, the third spring portion 131, and the fourth spring portion 141 may be irregularly shaped. In this case, size values for the height, the width, and the length may not be easily designed, but the height stiffness in the height direction and the width stiffness in the width direction can still be determined. Therefore, in this case, a ratio of the height stiffness to the width stiffness can be made to enable each of the first spring member 110, the second spring member 120, the third spring member 130, and the fourth spring member 140 to be able to be displaced in only the X-Y reference plane. Alternatively, at least the height stiffness is configured to cause each of the first spring portion 111, the second spring portion 121, the third spring portion 131, and the fourth spring portion 141 to be un-bendable in the height direction.

Further as shown in FIG. 3, the first spring member 110 includes a first connection portion 113, and the third spring member 130 includes a first connection portion 133. The first connection portion 113 of the first spring member 110 and the first connection portion 133 of the third spring member 130 are connected to a movable member of the VCM, as shown in FIG. 4. In this way, when the movable member of the VCM moves for OIS, the first connection portion 113 of the first spring member 110 and the first connection portion 133 of the third spring member 130 are moved synchronously to drive the first spring member 110 and the third spring member 130 to move in only the X-Y reference plane.

Specifically, the first spring portion 111 of each of the first spring member 110 has two first spring sub-portions 111a and 111b; the third spring portion 131 of each of the third spring member 130 has two third spring sub-portions 131a and 131b. The first connection portion 113 of the first spring member 110 is disposed between the two first spring sub-portions 111a and 111b. The third connection portion 133 of the third spring member 130 is disposed between the two third spring sub-portions 131a and 131b. The first connection portion 113 of the first spring member 110 is protruding from the two first spring sub-portions 111a and 111b in the width direction and has a flat connection surface to be connected to the movable member of the VCM.

The second spring member 120 includes a second connection portion 123, and the fourth spring member 140 includes a second connection portion 143. The second connection portion 123 of the second spring member 120 and the second connection portion 143 of the second spring member 140 are connected to a fixed member of the VCM.

Since the second spring member 120 and the fourth spring member 140 are connected to the first spring member 110 and the third spring member 130, connection between the second spring member and the fixed member of the VCM allows the first spring member 110 and the third spring member 130 to be reset to original positions after being driven to move along with the movable member of the VCM.

The second spring portion 121 of the second spring member 120 has two second spring sub-portions 121a and 121b, and the fourth spring portion 141 of the fourth spring member 140 has two fourth spring sub-portions 141a and 141b. The second connection portion 123 of the second spring member is disposed between the two second spring sub-portions 121a and 121b. The second connection portion 143 of the fourth spring member 140 is disposed between the two fourth spring sub-portions 141a and 141b. The second connection portion 123 of the second spring member is protruding from the two second spring sub-portions 121a and 121b in the width direction and has a flat connection surface connected to the fixed member of the VCM. The second connection portion 143 of the fourth spring member 140 is protruding from the two fourth spring sub-portions 141a and 141b in the width direction and has a flat connection surface connected to the fixed member of the VCM.

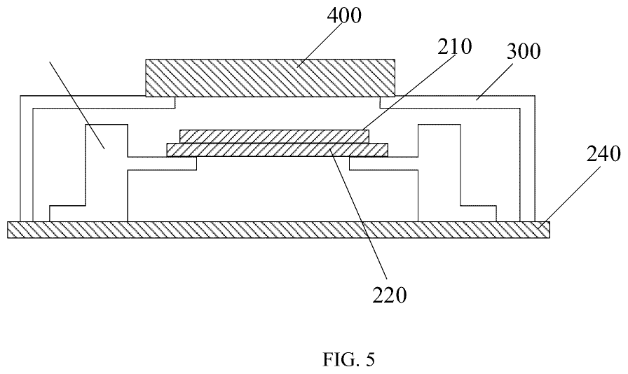

In some embodiments, as shown in FIG. 5, the second connection portion 123 of the second spring member 120 and the second connection portion 143 of the fourth spring member 140 are protruding in a first direction; the first connection portion 113 of the first spring member 110 and the first connection portion 133 of the third spring member 130 are protruding in a second direction opposite to the first direction.

Further as shown in FIG. 3, the first spring member 110 is arranged with two first assembly structures 115 respectively at two ends of the first spring member 110; the third spring member 130 is arranged with two third assembly structures 135 respectively at two ends of the third spring member 130. The second spring member 120 is arranged with two second assembly structures 125 respectively at two ends of the second spring member 120; and the fourth spring member 140 is arranged with two fourth assembly structures 145 respectively at two ends of the fourth spring member 140.

The two first assembly structures 115 of the first spring member 110 are respectively assembled with a respective one of the two second assembly structures 125 of the second spring member 120 and a respective one of the two fourth assembly structures 145 of the fourth spring member 140. The two third assembly structures 135 of the third spring member 130 are respectively assembled with the other respective one of the two second assembly structures 125 of the second spring member 120 and the other respective one of the two fourth assembly structures 145 of the fourth spring member 140. Assembling between the assembly structures can be configured in any form, such as assembling by insertion, assembling by engagement, assembling by snaps, and so on.

In an embodiment shown in FIG. 3, the assembling is achieved by insertion. That is, the first assembly structures 115 and the third assembly structures 135 are insertion holes; the second assembly structures 125 and the fourth assembly structures 145 are protrusion that can be inserted into the insertion holes correspondingly. A fixation member is arranged to further secure assembling between the assembly structures. For example, in the present application, after the protrusions are inserted into the insertion holes, glue may be applied between the protrusion and walls of the insertion holes.

In some embodiments, each of the first spring member 110, the second spring member 120, the third spring member 130, and the fourth spring member 140 may be configured as a one-piece and integral structure.

For example, the first spring portion 111, the first connection portion 113, and the two first assembly structures 115 are made as a one-piece and integral structure. The second spring portion 121, the second connection portion 123, and the two second assembly structures 125 are made as a one-piece and integral structure. The third spring portion 131, the first connection portion 133, and the two third assembly structures 135 are made as a one-piece and integral structure. The fourth spring portion 141, the second connection portion 143, and the two fourth assembly structures 145 are made as a one-piece and integral structure.

In an embodiment, each of the first spring member 110 and the third spring member 130 is formed by one sheet of metal; and each of the second spring member 120 and the fourth spring member 140 is formed by one sheet of metal. For example, one sheet of metal may be stamped to be bent at various sections to form each of the first spring member 110, the second spring member 120, the third spring member 130, and the fourth spring member 140, having configurations as described in the above. Taking the first spring member 110 as an example, the spring portion 111, the first connection portion 113, and the two first assembly structures 115 are various portions of one sheet of metal.

In the above embodiments, the planar metal spring includes fourth spring members connected to each other from end to end. Each of the four spring members has the height stiffness and the width stiffness. The ratio of the height stiffness to the width stiffness is specifically designed to enable the fourth spring members to be able to move in only the X-Y reference plane and to be unable to move along the Z direction perpendicular to the X-Y reference plane. In this way, by configuring the four spring members only (each of the four spring members is a one-piece and integral structure), a significant large stiffness in the height direction is achieved, such that the ball bearings in the art for increasing the height stiffness can be omitted. The non-linear friction generated by the ball bearings are eliminated, displacement of the VCM can be controlled precisely. A space for arranging the ball bearings can be saved, and therefore, an overall size of the VCM can be reduced. Since friction generated by the ball bearings is eliminated, power consumption of the VCM for driving movement can be saved.

In another embodiment, the present disclosure provides a voice coil motor (VCM) 200, as shown in FIG. 4. The VCM 200 includes a sensor 210, a movable member 220, the metal spring 100 as described in the above, and a fixed member 240.

The sensor 210 is configured to capture images and is arranged on and supported by a side of the movable member 220. The movable member 220 is movable when encountering vibration during image capturing, so as to enable the sensor 210 to stay at a fixed position relative a to-be-captured object. The metal spring 100 takes the first connection portion 113 of the first spring member 110 and the first connection portion 133 of the third spring member 130 to be connected to the movable member 220. The metal spring 100 is arranged on the fixed member 240 and takes the second connection portion 123 of the second spring member 120 and the second connection 145 of the fourth spring member 140 to be fixedly connected to the fixed member 240.

Since each of the four spring members has the height stiffness (in the Z direction) significantly greater than the width stiffness (in the X-Y plane), movement of the first spring members 110 and the third spring members 130, driven by the movable member 220 of the VCM only occurs in the X-Y plane. As can be seen in the FIGS. 4 and 5, connection between the metal spring 100 and the fixed member 240 and the movable member 220 does not need any ball bearing.

In another embodiment, the present disclosure provides a camera 1000, including the VCM 200 as described in the above, a holder 300, and a lens 400.

As shown in FIG. 5, the holder 300 is arranged on the fixed member 240, the spring metal 100, the moved member 220, and the sensor 210 are arranged inside the holder 300. The lens 400 is configured to allow light to pass through to reach the sensor 210 and is arranged on and supported by the holder 300.

In summary, the camera of the present disclosure is arranged with the VCM, and the VCM is arranged with the planar metal spring as described in the above. The planar metal spring includes fourth spring members connected to each other from end to end. Each of the four spring members has the height stiffness and the width stiffness. The ratio of the height stiffness to the width stiffness is specifically designed to enable the fourth spring members to be able to move in only the X-Y reference plane and to be unable to move along the Z direction perpendicular to the X-Y reference plane. In this way, by configuring the four spring members only (each of the four spring members is a one-piece and integral structure), a significant large stiffness in the height direction is achieved, such that the ball bearings in the art for increasing the height stiffness can be omitted. The non-linear friction generated by the ball bearings are eliminated, displacement of the VCM can be controlled precisely. A space for arranging the ball bearings can be saved, and therefore, an overall size of the VCM and the camera can be reduced. Since friction generated by the ball bearings is eliminated, power consumption of the VCM for driving movement can be saved.

The above description shows only optional embodiments of the present disclosure and is not intended to limit the present disclosure, and any modifications, equivalent substitutions, improvements made within the spirit and principles of the present disclosure shall be included in the scope of the present disclosure.

What is claimed is:

1. A metal spring, configured for a voice coil motor (VCM), the metal spring comprising: a first spring member, a second spring member, a third spring member, and a fourth spring member,
wherein the first spring member and the third spring member are extending in parallel to each other; the second spring member is connected between an end of the first spring member and an end of the third spring member; the fourth spring member is connected between the other end of the first spring member and the other end of the third spring member;
a reference plane in which the first spring member, the second spring member, the third spring member, and the fourth spring member are arranged and connected to each other is formed;
each of the first spring member, the second spring member, the third spring member, and the fourth spring member comprises a respective spring portion, the spring portion is extending in a length direction and has a width in a width direction and a height in a height direction, the width direction and the length direction are extending in the reference plane and are perpendicular to each other, the height direction is perpendicular to the reference plane;
a ratio of the height to the width of the respective spring portion is configured to enable each of the first spring member, the second spring member, the third spring member, and the fourth spring member to be capable of being displaced in only the reference plane.

2. The metal spring according to claim 1, wherein the respective spring portion has a height stiffness in the height direction and a width stiffness in the width direction;
a ratio of the height stiffness to the width stiffness of the respective spring portion is configured to enable each of the first spring member, the second spring member, the third spring member, and the fourth spring member to be capable of being displaced in only the reference plane.

3. The metal spring according to claim 2, wherein the height stiffness is configured to cause each of the first spring member, the second spring member, the third spring member, and the fourth spring member to be un-bendable in the height direction.

4. The metal spring according to claim 1, wherein each of the first spring member and the third spring member further comprises a respective first connection portion configured to be connected to a movable member of the VCM.

5. The metal spring according to claim 4, wherein each of the first spring member and the third spring member is configured to be driven to move in only the reference plane by the movable member of the VCM through the respective first connection portion.

6. The metal spring according to claim 4, wherein the respective spring portion of each of the first spring member and the third spring member has a first spring sub-portion and a second spring sub-portion, and the respective first connection portion of each of the first spring member and the third spring member is disposed between the first spring sub-portion and the second spring sub-portion.

7. The metal spring according to claim 6, wherein the first connection portion is protruding from the first spring sub-portion and the second spring sub-portion in the width direction and has a flat connection surface.

8. The metal spring according to claim 4, wherein each of the second spring member and the fourth spring member further comprises a respective second connection portion configured to be connected to a fixed member of the VCM.

9. The metal spring according to claim 8, wherein the respective spring portion of each of the second spring member and the fourth spring member has a first spring sub-portion and a second spring sub-portion, and the respective second connection portion of each of the second spring member and the fourth spring member is disposed between the first spring sub-portion and the second spring sub-portion.

10. The metal spring according to claim 9, wherein the second connection portion is protruding from the first spring sub-portion and the second spring sub-portion in the width direction and has a flat connection surface.

11. The metal spring according to claim 1, wherein each of the end and the other end of each of the first spring member and the third spring member is arranged with a first assembly structure;
each of the end and the other end of each of the second spring member and the fourth spring member is arranged with a second assembly structure;
the first assembly structure and the second assembly structure are assembled with each other to cause the second spring member to be connected to the first spring member and the third spring member and cause the fourth spring member to be connected to the first spring member and the third spring member.

12. The metal spring according to claim 11, wherein the first connection structure is an insertion hole; and the second assembly structure is a protrusion inserted into the insertion hole.

13. The metal spring according to claim 11, wherein assembling between the first assembly structure and the second assembly structure is further fixed by a fixation member.

14. The metal spring according to claim 13, wherein the fixation member is glue.

15. The metal spring according to claim 8, wherein each of the first spring member and the third spring member, which comprises the respective spring portion and the respective first connection portion, is configured as an integral and one-piece structure; and
each of the second spring member and the fourth spring member, which comprises the respective spring portion and the respective second connection portion, is configured as an integral and one-piece structure.

16. The metal spring according to claim 15, wherein each of the first spring member and the third spring member, which comprises the respective spring portion and the respective first connection portion, is formed by one sheet of metal; and
each of the second spring member and the fourth spring member, which comprises the respective spring portion and the respective second connection portion, is formed by one sheet of metal.

17. The metal spring according to claim 1, wherein the respective spring portion is bendable in one or more directions.

18. A voice coil motor, comprising:
a metal spring;
a movable member; and
a fixed member;
wherein the metal spring comprises: a first spring member, a second spring member, a third spring member, and a fourth spring member,
wherein the second spring member is connected between an end of the first spring member and an end of the third spring member; the fourth spring member is connected between the other end of the first spring member and the other end of the third spring member;
each of the first spring member, the second spring member, the third spring member, and the fourth spring member comprises a respective spring portion, the spring portion is extending in a length direction and has a width in a width direction and a height in a height direction, the width direction and the length direction are perpendicular to each other, the height direction is perpendicular to the length direction and the width direction;
a ratio of the height to the width of the respective spring portion is configured to enable each of the first spring member, the second spring member, the third spring member, and the fourth spring member to be capable of being displaced in only the width direction;
the movable member is connected to the first spring member and the third spring member; the fixed member is connected to the second spring member and the fourth spring member.

19. A camera, comprising a lens, a holder, and the voice coil motor according to claim 18, wherein the lens is arranged on and supported by the holder, and the voice coil motor is arranged inside the holder.
